(19) United States
(12) Patent Application Publication
(10) Pub. No.: US 2010/0300928 A1
(43) Pub. Date: Dec. 2, 2010

(54) AQUEOUS COMPOSITIONS FOR ENHANCED HYDROCARBON FLUID RECOVERY AND METHODS OF THEIR USE

(75) Inventors: John D. Oates, Midland, MI (US); James G. Galloway, Midland, MI (US); Dwayne J. Nicholson, Sanford, MI (US)

Correspondence Address: The Dow Chemical Company;Brooks, Cameron, PLLC, 1221 Nicollet Avenue, Suite 500, Minneapolis, MN, 55403, US

(73) Assignee: DOW GLOBAL TECHNOLOGIES INC., Midland, MI (US)

(21) Appl. No.: 12/790,263

(22) Filed: May 28, 2010

Related U.S. Application Data
(60) Provisional application No. 61/217,325, filed on May 29, 2009.

(51) Int. Cl. C09K 8/588; C09K 8/58; H01B 3/22; E21B 43/16

(52) U.S. Cl. 208/14; 507/219; 507/224; 507/225; 166/305.1

(57) ABSTRACT

Embodiments of the present disclosure include compositions for enhanced oil recovery and methods of using the same. Compositions of the present disclosure include particles of a hydrophobic polymer having constitutional repeating units of which at least 10 percent are hydrolysable and through hydrolysis increase a viscosity of the aqueous composition within a subterranean formation.

This application claims the benefit of U.S. Provisional Application No. 61/217,325 filed May 29, 2009, the entire content of which is incorporated herein by reference.

### FIELD OF DISCLOSURE

Embodiments of the present disclosure are directed toward enhanced hydrocarbon fluid recovery; more specifically, embodiments of the present disclosure include aqueous compositions for enhanced hydrocarbon fluid recovery and methods of using the aqueous compositions in hydrocarbon fluid recovery processes.

### BACKGROUND

A variety of techniques have been used to enhance the recovery of hydrocarbon fluids from subterranean formations in which the hydrocarbon fluids no longer flow by natural forces. Such techniques can include water injection and/or subsequent gas flooding, among others, and are known as secondary recovery processes.

The fluids normally used in secondary recovery processes are water (such as aquifer water, river water, or produced water), or gas (such as produced gas, carbon dioxide, flue gas, and various others). If the fluid encourages movement of normally immobile residual oil or other hydrocarbon fluids, the process is termed a tertiary recovery process.

A problem with secondary and tertiary recovery processes relates to the heterogeneity of the subterranean formation rock strata. For example, the mobility of the injected fluid can be different from the hydrocarbon fluids present in the reservoir. When the injected fluid is more mobile than the hydrocarbon fluids, various mobility control processes have been used to make the sweep of the reservoir more uniform and the consequent hydrocarbon fluid recovery more efficient. Such processes, however, have limited value when high permeability zones, called thief zones or streaks, exist within the reservoir rock. In such zones, the injected fluid has a low resistance route from the injection well to the production well in the reservoir. In such cases, the injected fluid does not effectively sweep the hydrocarbon fluid from adjacent, lower permeability zones.

Numerous physical and chemical methods have been used to divert injected fluids out of thief zones in or near production and injection wells. For example, one technique involves loading a subterranean area adjacent to the wellbore with a barrier, such as concrete, resin, or particulate matter, so that the loaded area is effectively plugged. The area above the loaded area is then perforated to begin production. Unfortunately, this method is nondiscriminating and tends to damage both the hydrocarbon fluid and water producing channels.

Other techniques have included the gelation of polyvinyl alcohol (PVA), polyacrylic acid, the condensation polymerization of phenol and formaldehyde within the reservoir formation's pore channels, and the use of swellable, cross-linked polymer microparticles. These processes are designed to damage and/or partially block the pore channel within the formation and restrict fluid movement through the channels. However, these techniques also have problems associated with each. For example, gelation and condensation polymerization of phenol and formaldehyde are nondiscriminating and can damage both the hydrocarbon fluid and water producing channels.

Also, in some instances, the swellable, cross-linked polymer microparticles are formed using an inverse water-in-oil emulsion or microemulsion polymerization process. In such instances, the process produces polymer microparticles in a solution containing significant amounts of organic solvent. Since a reservoir is typically filled with water from water-flooding procedures, in order to mix with water in the reservoir the solution is inverted to an aqueous solution with the addition of an inverting surfactant. Both the inverting surfactant and the polymer microparticles in the solution containing significant amounts of organic solvent can be injected into the reservoir, however, the use of an inverting surfactant or/and an organic solvent can increase the application cost. Alternatively, instead of using an inversion process, the polymer microparticles can be isolated from the solution containing significant amounts of organic solvent by precipitating, filtering, washing, and drying the polymer micropolymers, followed by redispersing the polymer micropolymers in water. However, the isolation of the polymer microparticles also can increase the application cost of using polymer microparticles formed using an inverse water-in-oil emulsion or microemulsion polymerization process.

Therefore, there exists a need for an improved process that does not suffer from the aforementioned disadvantages.

### SUMMARY

Embodiments of the present disclosure include aqueous compositions for use in recovering hydrocarbon fluids from subterranean formations, and methods of using the same. For the various embodiments, the aqueous compositions include particles of a hydrophobic polymer that, in an alkaline pH and at predetermined temperature, expand and can serve to modify a permeability of the subterranean formation.

For the various embodiments, the aqueous composition for enhanced hydrocarbon fluid recovery in the subterranean formation includes particles of a hydrophobic polymer having constitutional repeating units of which at least 10 percent can be hydrolyzed. This hydrolysis of the hydrophobic polymer helps to increase a viscosity of the aqueous composition within the subterranean formation. For the various embodiments, the at least 10 percent of the constitutional repeating units that are hydrolysable are available to undergo hydrolysis, but do not all necessarily undergo hydrolysis. As such, the at least 10 percent of the constitutional repeating units can either partially or completely undergo hydrolysis according to the present disclosure.

For the various embodiments, the particles of the hydrophobic polymer in the aqueous composition do not have to include a labile cross-linking agent (e.g., the particles of the hydrophobic polymer in the aqueous composition do not include a labile cross-linking agent). For the various embodiments, the particles of the hydrophobic polymer can maintain an unexpanded state, at a non-alkaline pH, without the labile cross-linking agent. For the various embodiments, the particles of the hydrophobic polymer can have an unexpanded volume average particle diameter of 0.05 to 10 micrometers.

Embodiments of the present disclosure include that the particles of the hydrophobic polymer can include a non-labile cross-linking agent, and that the non-labile cross-linking agent content can be in a range of 0.01 to 5 parts per 100 parts monomer of the hydrophobic polymer.

Embodiments of the present disclosure include a method for enhanced hydrocarbon fluid recovery including injecting an aqueous composition into a subterranean formation, where the aqueous composition includes particles of a hydrophobic polymer having constitutional repeating units of which at least 10 percent are hydrolysable. Embodiments of the method include allowing some, or all, of the at least 10 percent of the constitutional repeating units to hydrolyze within the subterranean formation to increase a viscosity of the aqueous composition. For the various embodiments, allowing the at least 10 percent of the constitutional repeating units to hydrolyze within the subterranean formation includes hydrolyzing each of the constitutional repeating units available for hydrolysis. For the various embodiments, allowing the at least 10 percent of the constitutional repeating units to hydrolyze within the subterranean formation includes hydrolyzing less than all of the constitutional repeating units available for hydrolysis. For the various embodiments, the method can include controlling an extent of expansion of the particles of the hydrophobic polymer with a variation in a temperature, a pH, an amount/type and/or concentration of added base, and a combination thereof in the subterranean formation. For the various embodiments, the method can include controlling an extent of expansion of the particles of the hydrophobic polymer with the types and amounts of monomers used to form the hydrophobic polymer. For the various embodiments, the particles of the hydrophobic polymer can expand to modify water permeability in the subterranean formation.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DEFINITIONS

As used herein, “a,” “an,” “the,” “at least one,” and “one or more” are used interchangeably. The terms “comprises,” “includes,” and variations thereof do not have a limiting meaning where these terms appear in the description and claims. Thus, for example, an aqueous composition that includes particles of “a” hydrophobic polymer can be interpreted to mean that the composition includes particles of “one or more” hydrophobic polymers.

Also herein, the recitations of numerical ranges by endpoints include all numbers subsumed in that range (e.g., 1 to 5 includes 1, 1.5, 2, 2.75, 3, 3.80, 4, 5, etc.).

Also herein, the recitations of numerical ranges and/or numerical values, including such recitations in the claims, can be read to include the term “about.” In such instances the term “about” refers to numerical ranges and/or numerical values that are substantially the same as those recited herein.

As used herein, the term an “alkaline pH” means a pH that is 8.0 or greater.

As used herein, the term a “non-alkaline pH” means a pH that is less than 8.0.

As used herein, the term “dry” means a substantial absence of liquids.

As used herein, the term “dry weight” refers to a weight of a dry material. For example, the solids content of the aqueous composition can be expressed as a dry weight, meaning that it is the weight of the aqueous composition remaining after essentially all liquid materials have been removed.

As used herein, the term “polymer” refers to a macromolecule composed of repeating units. Herein, the term polymer includes copolymers as well as homopolymers.

As used herein, the term “hydrophobic polymer” refers to a polymer with a calculated total solubility parameter of 13.0 or less (calories per cubic centimeter)^{1/2} ((cal/cc)^{1/2}). The total solubility parameter can be calculated for copolymers using group contribution terms according to Equation 1 and according to methods described in “New Values of the Solubility Parameters from Vapor Pressure Data” by K. L. Hoy, in Journal Paint Technology, 42, 76, 1970, “The Hoy Tables of Solubility Parameters” by K. L. Hoy, Union Carbide Corporation, 1985, and “The Algorithmic Calculations of Solubility Parameter for the Determination of Interactions in Dextrin/Certain Polar Solvent Systems” by A. Guner, in European Polymer Journal, 40, 1587, 2004.

δ_{T}=(δ²_{H-Bonding}+δ²_{Polar}+δ²_{Non-Polar})^{1/2} (Equation 1)
where
δ_{T} is the total solubility parameter;
δ_{H-Bonding} is the hydrogen bonding solubility parameter;
δ_{Polar} is the polar solubility parameter; and
δ_{Non-Polar} is the non-polar solubility parameter.

As used herein, the term “hydrophobic monomer” refers to monomers that have 10 weight percent or less solubility in water at 23 degrees Celsius.

As used herein, the term “particle” refers to at least one of a polymer particle that can be a discrete particle or an agglomeration of two or more discrete particles in an aqueous composition, where a synthetic latex is an example of a dispersion of polymer particles in an aqueous medium.

As used herein, the term “aqueous composition” refers to a composition in which the polymer particles are present in water. An aqueous composition, however, can also include additional organic components and/or inorganic components not exceeding 50 weight percent of the aqueous composition.

For the purposes of the present disclosure, the term “copolymer” means a polymer derived from more than one species of monomer.

As used herein, the term particle size refers to a “volume average particle diameter” as measured by dynamic light scattering, herein, as measured by a Microtrac UPA 150 Particle Size Analyzer (available from Microtrac, Inc., Montgomery, Pa., USA).

As used herein, the term “cross-linking monomer” refers to an ethylenically unsaturated monomer containing at least two sites of ethylenic unsaturation which can be added to constrain the conformation of the particles.

As used herein, a “labile cross-linking monomer,” or labile cross-linking agent, refers to a cross-linking monomer which can be degraded by certain conditions of temperature and/or pH after it has been incorporated into a polymer structure, to reduce the degree of cross-linking in the polymer particles. The aforementioned conditions are such that they can cleave bonds in the “labile cross-linking monomer” without substantially degrading the rest of the polymer backbone.

As used herein, a “non-labile cross-linking monomer,” or non-labile cross-linking agent, refers to a cross-linking monomer which is not substantially degraded under the conditions of temperature and/or pH which cause incorporated labile cross-linking monomers to degrade or disintegrate.

As used herein, “constitutional repeating units” refers to the smallest constitutional unit (a group of atoms comprising a part of the essential structure of a macromolecule), or monomer, the repetition of which constitutes a macromolecule, such as a polymer.

As used herein, “viscosity” refers to the ratio of a shearing stress to the velocity gradient in a fluid. Viscosity can be used to describe a fluid's resistance to flow.

As used herein, “° C.” is an abbreviation for degrees Celsius.

As used herein, the term “synthetic latex” refers to a dispersion of polymer particles in an aqueous medium.

As used herein, an “alkali swellable latex” refers to a synthetic latex whose polymer particles include acid groups that can undergo at least partial ionization upon addition of a pH increasing agent or material with hydration of the ionized polymer particles leading to swelling and an increase in a viscosity of the alkali swellable latex.

### DETAILED DESCRIPTION

The present disclosure provides embodiments of aqueous compositions for use in enhanced hydrocarbon fluid recovery and methods of using the same aqueous compositions in hydrocarbon fluid recovery processes. For the various embodiments, the aqueous compositions include particles of a hydrophobic polymer that are hydrolysable and through hydrolysis increase a viscosity of the composition within a subterranean formation.

As described herein, the aqueous composition of the present disclosure includes particles of the hydrophobic polymer that are hydrolysable and that undergo hydrolysis to increase a viscosity of the composition within a subterranean formation. One skilled in the art will recognize that the aqueous composition of the present disclosure can be diluted and/or combined with other components before being injected into the subterranean formation. For example, the aqueous composition can be combined with caustic solutions, brine solutions, inorganic materials and/or organic materials, among other components. As appreciated, the aqueous composition can be combined with other components before being injected into the subterranean formation and/or the other components can be injected into the subterranean formation simultaneously with, and/or subsequent to, the aqueous composition injection.

The particles of the hydrophobic polymer included in the aqueous compositions of the present disclosure can be prepared using an emulsion polymerization process in an aqueous medium. The term “emulsion polymerized” refers to polymers which are prepared in an aqueous medium by an emulsion polymerization process. Synthetic latexes are commonly prepared on a commercial scale via emulsion polymerization.

The term “seed” polymer refers to a polymer dispersion which may be the initially formed dispersion that is the product of a single stage of emulsion polymerization.

The particles of hydrophobic polymer of the present disclosure may be the product of aqueous emulsion polymerization of one or more monomers to produce constitutional repeating units in the particle, of which at least 10 percent are hydrolysable and are available to undergo hydrolysis. By including at least 10 parts of the hydrolysable monomer based on 100 parts by weight of the hydrophobic polymer, the hydrolysable constitutional repeating units of the particles of the hydrophobic polymer can hydrolyze, causing a change in volume average particle diameter in aqueous compositions that can be useful in applications in subterranean formations, as discussed further herein.

In some embodiments, the particles of hydrophobic polymer can include constitutional repeating units of which at least 10 percent are hydrolysable and can undergo hydrolysis. In various embodiments, the particles of hydrophobic polymer can include constitutional repeating units of which at least 30 percent are hydrolysable and can undergo hydrolysis. In further embodiments, the particles of hydrophobic polymer can include constitutional repeating units of which at least 50 percent are hydrolysable and can undergo hydrolysis. In some embodiments, the particles of hydrophobic polymer can include constitutional repeating units of which 100 percent are hydrolysable and can undergo hydrolysis. Intermediate values between these recited values are also possible, and include, but are not limited to, 20, 40, 60, 80, 90, 95, 96, 97, 98, and 99 percent of the constitutional repeating units that are hydrolysable and can undergo hydrolysis according to the present disclosure.

For the various embodiments, the particles of hydrophobic polymer having constitutional repeating units, as discussed herein, that are available to undergo hydrolysis to increase a viscosity of the aqueous composition within the subterranean formation may or may not all undergo hydrolysis. For example, the constitutional repeating units that are available to undergo hydrolysis, as discussed herein, may all undergo hydrolysis so as to increase the viscosity of the aqueous composition within the subterranean formation. It is also possible that less than all of the constitutional repeating units that are available to undergo hydrolysis, as discussed herein, undergo hydrolysis so as to increase the viscosity of the aqueous composition within the subterranean formation.

In various embodiments, the weight percent and type of hydrolysable constitutional repeating units included in the particles of hydrophobic polymer can be tailored to and/or tailored on the conditions in the subterranean formation. For example, as the temperature of the subterranean formation increases, the weight percent of hydrolysable constitutional repeating units included in the particles of hydrophobic polymer can be decreased and/or the hydrolysable constitutional repeating units included in the particles of the hydrophobic polymer can be chosen to be slower to hydrolyze relative to other hydrolysable constitutional repeating units that can be included in the particles of the hydrophobic polymer (e.g., for those intended for lower temperature formations).

For the various embodiments, the monomers used to form the hydrophobic polymer can include a hydrolysable monomer selected from the group of methyl acrylate, ethyl acrylate, 2-hydroxyethyl acrylate, n-butyl acrylate, tert-butyl acrylate, sec-butyl acrylate, n-propyl acrylate, acrylonitrile, vinyl acetate, and combinations thereof. In some embodiments, the hydrolysable monomers can be hydrophobic. In some embodiments, the particles of the hydrophobic polymer can be formed from monomers, of which at least 90 weight percent are hydrophobic monomers.

In some embodiments, the monomers used to form the hydrophobic polymer can include 5 or more parts of the hydrolysable monomer based on 100 parts by weight of the hydrophobic polymer. In some embodiments, the monomers used to form the hydrophobic polymer can include 10 or more parts of the hydrolysable monomer based on 100 parts by weight of the hydrophobic polymer. In some embodiments, the monomers used to form the hydrophobic polymer can include up to 96 parts of the hydrolysable monomer based on 100 parts by weight of the hydrophobic polymer. In various embodiments, the monomers used to form the hydrophobic polymer can include up to 98 parts of the hydrolysable monomer based on 100 parts by weight of the hydrophobic polymer. In various embodiments, the monomers used to form the hydrophobic polymer can include up to 99 parts of the hydrolysable monomer based on 100 parts by weight of the hydrophobic polymer. In some embodiments, the monomers used to form the hydrophobic polymer can include up to and including 100 parts of the hydrolysable monomer based on 100 parts by weight of the hydrophobic polymer.

In some embodiments, the particles of hydrophobic polymer can include hydrophilic constitutional repeating units and/or non-hydrolysable constitutional repeating units in addition to the hydrolysable constitutional repeating units. For example, the monomer or mixture of monomers can be copolymerized with one or more ethylenically unsaturated monomers having non-hydrolysable character (i.e., having no hydrolysable group), and having no hydrolysable group. Examples of non-hydrolysable monoethylenically unsaturated monomers having no hydrolysable groups include styrene, vinyltoluene, ethylene, vinyl chloride, vinylidene chloride. In some embodiments, the hydrophobic polymer may also include various (C₁-C₂₀)alkyl or (C₃-C₂₀)alkenyl esters of (meth)acrylic acid, where the expression (meth)acrylic acid is intended to serve as a generic expression embracing both acrylic acid and (meth)acrylic acid.

In various embodiments, the ethylenically unsaturated monomers having non-hydrolysable character can include a monoethylenically unsaturated carboxylic acid. For the various embodiments, monomers of the monoethylenically unsaturated carboxylic acid can include monoethylenically unsaturated carboxylic acids having from 3 to 8 carbon atoms, such as, for example, acrylic acid, methacrylic acid, dimethacrylic acid, ethacrylic acid, maleic acid, citraconic acid, methylenemalonic acid, allylacetic acid, vinylacetic acid, crotonic acid, fumaric acid, mesaconic acid, itaconic acid, and combinations thereof.

In some embodiments, the particles of the hydrophobic polymer can be formed with 90 weight percent of a hydrolysable monomer based on 100 parts by weight of the hydrophobic polymer and 10 weight percent of a non-hydrolysable monomer based on 100 parts by weight of the hydrophobic polymer. In some embodiments, the particles of the hydrophobic polymer can be formed with 70 weight percent of a hydrolysable monomer based on 100 parts by weight of the hydrophobic polymer and 30 weight percent of a non-hydrolysable monomer based on 100 parts by weight of the hydrophobic polymer. In some embodiments, the particles of the hydrophobic polymer can be formed with the hydrolysable monomer in a range of 20 to 100 weight percent, preferably 40 to 100 weight percent, and most preferably 70 to 100 weight percent, based on 100 parts by weight of the hydrophobic polymer, where the balance is formed with the non-hydrolysable monomer.

For the various embodiments, the particles of the hydrophobic polymer can also be formed with at least 92 weight percent of the hydrolysable monomer and 8 weight percent or less of ethylenically unsaturated monomers having non-hydrolysable character. For the various embodiments, the particles of the hydrophobic polymer can also be formed with at least 96 weight percent of the hydrolysable monomer and 4 weight percent or less of ethylenically unsaturated monomers having non-hydrolysable character. For the various embodiments, the particles of the hydrophobic polymer can also be formed with at 99.9 to 96 weight percent of the hydrolysable monomer and 0.1 to 4 weight percent of ethylenically unsaturated monomers having non-hydrolysable character.

For the various embodiments, the amount and type of ethylenically unsaturated monomers used in forming the particles of the hydrophobic polymer can be selected based on a number of factors. Such factors can include, but are not limited to, the amount (if any) of non-labile cross-linking agent used, the specific carboxylic acid(s) chosen and/or the composition of the remainder of the hydrophobic polymer, and the temperature and/or the salinity of the reservoir in which the particle is to be used. In addition, it is appreciated that as the content of the monoethylenically unsaturated carboxylic acid increases in the particle, so will the viscosity of the aqueous composition as the pH is increased.

The particles of the hydrophobic polymer may be derived by the emulsion polymerization of such monomers listed herein, or by copolymerization of two or more monomers. For the various embodiments, the particles of the hydrophobic polymer can be prepared by a free-radical emulsion polymerization in which an aqueous phase is the continuous phase. As is common to emulsion polymerization in an aqueous phase, a water-soluble free radical initiator, such as hydrogen peroxide, tert-butyl peroxide, or an alkali metal (sodium, potassium, or lithium) or ammonium persulfate can be used in the emulsion polymerization process. Initiators are well-known to those skilled in the art and are readily commercially available. In some embodiments, the amount of initiator may be from 0.01 to 2 weight percent of the monomer charged.

Surfactants may also be used during the emulsion polymerization process, as well-known to those skilled in the art. Examples of emulsion polymerization surfactants include sodium lauryl sulfate, sodium dodecyl benzene sulfonate, and DOWFAX 2A1 (available from The Dow Chemical Company, Midland Mich., USA), among others.

The temperature during the emulsion polymerization can range from 50° C. to 150° C. The polymerization time can range from 1 hour to 10 hours depending on the pressure and temperature during the emulsion polymerization process.

In some embodiments, the particles of the hydrophobic polymer do not have to include a labile cross-linking agent. Labile cross-linking agents have been used with particles of a hydrophilic polymer in order to maintain the particles of the hydrophilic polymer in an unexpanded state when in an aqueous composition. Such particles including the labile cross-linking agent can expand when the labile cross-linking agent is hydrolyzed or otherwise degraded under conditions of temperature and/or pH that can be expected in subterranean formations. The particles of the present disclosure, on the other hand, are hydrophobic, therefore, the particles can remain in an unexpanded state in the aqueous composition without the need of a labile cross-linking agent. As appreciated, however, a labile cross-linking agent can be used if desired.

The particles of the present disclosure, however, can include a non-labile cross-link. A non-labile cross-link included in the particles of the present disclosure is not hydrolyzed or otherwise degraded under conditions of temperature and/or pH that would cause labile cross-links to hydrolyze. The inclusion of a non-labile cross-linking agent can be used to control the size increase of the particles of the hydrophobic polymer when expanded, as well as prevent the particles of the hydrophobic polymer from being dissolved in the aqueous composition and/or in a water-containing subterranean formation following hydrolysis, as discussed further herein. In some embodiments, the particles of the hydrophobic polymer can have a non-labile cross-linking agent content of 0.01 to 5 parts per 100 parts monomer of the hydrophobic polymer.

A non-labile cross-linking agent refers to a monomer that is incorporated into the particles of the hydrophobic polymer and results in a non-labile cross-link. Examples of such monomers can include di- and trifunctional monomers such as, for example, divinyl benzene, or diene functional monomers such as butadiene.

In some embodiments, the particles of the hydrophobic polymer can have an unexpanded volume average particle diameter of 0.05 to 10 micrometers. In some embodiments, the particles of the hydrophobic polymer can have an unexpanded volume average particle diameter of 0.1 to 5 micrometers, preferably 0.12 to 3 micrometers. In some embodiments, the particle size of the hydrophobic polymer can be a function of pore size in the subterranean formation and/or to what extent the particles of hydrophobic polymer can expand. The extent of expansion can be controlled in a number of ways, including, but not limited to, the amount of non-labile cross-linking agent included in the particles of the hydrophobic polymer, as well as the hydrophobic monomers selected to form the particles of the hydrophobic polymer, among others. In some embodiments, the particle size of the hydrophobic polymer can be controlled by the amount of seed latex in the emulsion polymerization, and/or the surfactant introduced into the emulsion polymerization reaction.

In some embodiments, the particles of the hydrophobic polymer can include a hydrophobic polymer with a calculated total solubility parameter of 13.0 (cal/cc)^{1/2} or less. In various embodiments, the hydrophobic polymer can have a calculated total solubility parameter of 12.0 (cal/cc)^{1/2} or less. Further, the hydrophobic polymer can have a calculated total solubility parameter of 11.0 (cal/cc)^{1/2} or less. The optimal total solubility parameter for hydrophobic polymers for use in each subterranean formation can vary depending on, for example, the rate of hydrolysis and/or rate of expansion of the particles of the hydrophobic polymer at a given reservoir temperature.

As one skilled in the art will appreciate, since conditions within a subterranean formation can vary within the formation itself as well as between different formations, (e.g., temperature range from 30° C. to 275° C.), the particles of the hydrophobic polymer of the present disclosure can be formed with an unexpanded volume average particle diameter and a target increase in volume average particle diameter to fit the conditions of the particular subterranean formation.

As discussed herein, the particles of the hydrophobic polymer of the present disclosure have constitutional repeating units that are hydrolysable and can undergo hydrolysis. In some embodiments, the constitutional repeating units that are hydrolysable are latent acids that, upon hydrolysis, form acids (e.g., esters hydrolyze to an acid). Hydrolysis of latent acids to acids causes the hydrophobic polymer having the constitutional repeating units to become hydrophilic. As such, the particles of the hydrophobic polymer can absorb aqueous liquids (e.g., water) within the subterranean formation and expand once the constitutional repeating units that are hydrolysable undergo hydrolysis.

In some embodiments, the hydrolysis of the constitutional repeating units that are hydrolysable can be achieved by exposing the particles of the hydrophobic polymer to a strong alkaline solution, such as a sodium hydroxide solution, in an amount sufficient to raise the pH of the solution surrounding the particles of the hydrophobic polymer to pH of at least 8.0 or greater. For example, the expansion can occur at a temperature of at least 30° C. and a pH of at least 8.0 or greater. In various embodiments, at higher expansion temperatures, the rate of expansion of constitutional repeating units that are hydrolysable can be controlled by. including a labile cross-link. In such embodiments, the labile cross-link can hydrolyze under conditions appropriate for use in the subterranean formation of interest. In addition, the expansion time can depend on the monomer used in making the particles of the hydrophobic polymer, as well as the amount of base injected with the particles of the hydrophobic polymer and the temperature, salinity, and pH of the subterranean formation, as well as the flow rate through the subterranean formation.

As stated herein, embodiments of the present disclosure can be useful in secondary recovery processes to recover hydrocarbon fluids from a subterranean formation. As discussed herein, secondary recovery processes can include water flooding, where water is injected into the subterranean formation in order to channel the hydrocarbon fluids in the subterranean formation toward the production well. However, water in a subterranean formation can seek the most porous substrates, which effectively channels the water rather than pushing the hydrocarbon fluids toward a production well. In such instances, these porous substrates are sought to be closed off in order to block the passage of water. Production improvements in secondary recovery processes can be facilitated by adding the aqueous composition of the present disclosure to the water flood which is designed to be activated within the desired zones of high permeability.

The aqueous composition of the present disclosure can be used in a method for enhanced hydrocarbon fluid recovery by modifying the permeability to water of a subterranean formation. For example, the aqueous composition can be injected into the subterranean formation; the aqueous composition can then flow through a zone or zones of relatively high permeability in the subterranean formation until the aqueous composition reaches the portion of the subterranean formation that is the target for permeability modification. For the various embodiments, the method includes allowing the at least 10 percent of the constitutional repeating units of the polymer particles to hydrolyze within the subterranean formation to increase a viscosity of the aqueous composition. For example, once the polymer particles with at least 10 percent of the constitutional repeating units hydrolyze, the particles of the hydrophobic polymer become more hydrophilic and can absorb aqueous liquids (e.g., water) in order to expand. As discussed herein, other values for the weight percent of the constitutional repeating units that are available to undergo hydrolysis are also possible.

As appreciated by one skilled in the art, allowing the at least 10 percent of the constitutional repeating units to hydrolyze does not necessarily mean that all of the constitutional repeating units will undergo hydrolysis. In some embodiments, allowing the at least 10 percent of the constitutional repeating units to hydrolyze within the subterranean formation includes hydrolyzing all of the constitutional repeating units available for hydrolysis. However, other embodiments also provide for instances where less than all of the at least 10 percent of the constitutional repeating units available to undergo hydrolysis actually undergo hydrolysis.

The expansion of the particles of the hydrophobic polymer can fill or block the pores in the high permeability zones, or thief zones, of the subterranean formation. By blocking the high flow pathways, the water is forced into the low permeability zones and can “push” the hydrocarbon fluid toward the production well. The expansion of the particles of the hydrophobic polymer can also increase the viscosity of the aqueous composition in the thief zones, thereby further decreasing the mobility of the aqueous composition residing in the thief zones. The reduced mobility in the thief zones can result in more of the injected water flowing to other zones, resulting in higher sweep efficiencies and greater hydrocarbon fluid recovery. The viscosity of the aqueous composition in the thief zones may also be controlled by the concentration of the particles of the hydrophobic polymers in the aqueous composition, the composition and size of the particles of the hydrophobic polymer, and/or the amount, type, and concentration of added base

In some embodiments, the hydrophobic polymer can be chosen based on how rapidly or how slowly the at least 10 percent of the constitutional repeating units can hydrolyze, such that the aqueous composition can travel to the appropriate portion of the subterranean formation and hydrolyze. In some embodiments, the aqueous composition can be injected into the subterranean formation and then the injection of additional water being sent into the subterranean formation can be stopped in order to keep the aqueous composition in the appropriate portion of the subterranean formation until hydrolysis and expansion of the particles of the hydrophobic polymer occurs.

In some embodiments, the viscosity of the aqueous composition having 30 or more weight percent of the particles is less than 20 cP at a temperature of 23° C. before the constitutional repeating units undergo hydrolysis. In some embodiments, the viscosity of the aqueous composition having 3 or more weight percent of the particles of the present disclosure is less than 20 cp at 23° C. and at a pH of 10 or greater before the constitutional repeating units undergo hydrolysis. In some embodiments, the viscosity of the aqueous composition having 3 or more weight percent of the particles of the present disclosure is less than 10 cp at 23° C. and at a pH of 10 or greater before the constitutional repeating units undergo hydrolysis. In some embodiments, the viscosity of the aqueous composition having 3 or more weight percent of the particles of the present disclosure is less than 5 cp at 23° C. and at a pH of 10 or greater before the constitutional repeating units undergo hydrolysis.

As one skilled in the art will appreciate, the relatively low viscosity at a pH of 10 or greater illustrates that the particles of the hydrophobic polymer are hydrophobic before undergoing hydrolysis, and do not rapidly increase in viscosity when a pH increasing material is added. In addition, since the viscosity of the aqueous composition can be relatively low when it is injected, as compared to the viscosity of the aqueous composition when the particles are expanded, the composition of the present disclosure can be readily injected through the reservoir zones near the injection well and propagate far from the injection point until the composition encounters the portion of the subterranean formation that is to be blocked.

The particles used in the aqueous composition of the present disclosure also display a response to an alkaline environment that is very different than the response of an alkali swellable latex. As discussed herein, an alkali swellable latex includes polymer particles having acid groups that are immediately available to undergo at least partial ionization under an alkaline condition. Examples of such alkali swellable latexes are found in U.S. Pat. No. 7,488,705, among others. The immediate ionization of the alkali swellable latex then leads to hydration and swelling of the ionized polymer particles with a very rapid and large increase in a viscosity of the alkali swellable latex.

In contrast, the particles used in the aqueous composition of the present disclosure undergo (relative to an alkali swellable latex) a very slow and minor viscosity increase when the pH is increased, since relatively few acid groups are initially present and accessible for ionization. For the particles of the present disclosure, large magnitude increases in viscosity and particle swelling can be delayed until the hydrolysis reaction occurs and forms acid groups along the particle polymer chains. This delay in particle swelling and viscosity increase of the aqueous composition of the present disclosure can be advantageous in oil recovery operations, as it allows for greater injectivity of the particles near the wellbore, and allows the particles to be injected further from the wellbore before plugging the reservoir.

In some embodiments, the aqueous composition can be injected into the subterranean formation with a strong alkaline solution. In some embodiments, a strong alkaline solution can be injected with the aqueous composition, or as a separate stream, into the subterranean formation in order to hydrolyze the particles of the hydrophobic polymer. The strong alkaline solution can be formed with, for example, sodium hydroxide and/or potassium hydroxide, among other bases. In addition, the particles of the hydrophobic polymer can be hydrolyzed with an alkaline solution formed with a weak base, including ammonium hydroxide and/or sodium carbonate. In some embodiments, the alkaline solution can be chosen based on the conditions of the subterranean formation, including temperature, salinity, pH, etc.

In some embodiments, the rate of expansion of the particle of the hydrophobic polymer can be affected by the conditions of the subterranean formation. For example, the size of the expansion can be controlled by the amount of non-labile cross-links in the particle of the hydrophobic polymer, the type of hydrophobic polymer, the type, amount, and concentration of base injected with the particles of the hydrophobic polymer, as well as the temperature, pH, and pressure in the subterranean formation. In addition, the salinity of the subterranean formation can reduce the amount of expansion that the particle of the hydrophobic polymer can undergo, therefore, the aqueous composition can be adjusted to include polymer compositions with a greater inherent tendency to expand, polymer compositions which are less sensitive to salinity changes, and/or larger polymer particles (e.g., particles having larger average volume diameters) of the hydrophilic polymer which may effectively plug the reservoir in a less expanded condition in order to compensate for the effects of salinity on the expansion of the particles of the hydrophobic polymer.

In some embodiments, the particle size of the hydrophobic polymer before expansion can be selected based on the calculated pore size of the highest permeability zone in the subterranean formation. The time for expansion and thus viscosity increase, can be determined based on the type of monomers used in the polymerization process to form the particles of the hydrophobic polymer. In some embodiments, the subterranean formation can be treated with an aqueous composition having 5 weight percent and below of the particles of the hydrophobic polymer. In some embodiments, the subterranean formation can be treated with an aqueous composition having 0.05 weight percent to 10 weight percent of the particles of the hydrophobic polymer. Other weight percentages for the particles of the hydrophobic polymer in the aqueous composition are also possible.

In some embodiments, compositions of the present disclosure can include other additives. For example, the composition can include corrosion inhibitors, co-surfactants, scale inhibitors, mixtures thereof, as well as other additives that may enhance permeability control and/or the oil recovery process.

It is to be understood that the above description has been made in an illustrative fashion, and not a restrictive one. Although specific embodiments have been illustrated and described herein, those of ordinary skill in the art will appreciate that other component arrangements can be substituted for the embodiments shown. The claims are intended to cover such adaptations or variations of various embodiments of the disclosure.

Embodiments of the present disclosure are illustrated by the following examples. It is to he understood that the particular examples, materials, amounts, and procedures are to be interpreted broadly in accordance with the scope and spirit of the invention as set forth herein.

### EXAMPLES

The following examples are given to illustrate, but not limit, the scope of this disclosure. Weight percent is the percentage of one component included in a total mixture. The weight percent can be determined by dividing the dry weight of one component by the total dry weight of the mixture and then multiplying by 100. Unless otherwise specified, all instruments and chemicals used are commercially available.

Unless stated otherwise, viscosity is measured using a Brookfield DV-II viscometer at 23° C. and 50 rotations per minute (rpm) (available from Brookfield Engineering Laboratories, Inc., Middleboro, Mass., USA) using a spindle appropriate for the viscosity of the material being measured, the choice of which can be readily determined by one skilled in the art.

### Examples 1-3

Latex polymer dispersions are prepared using an emulsion polymerization method.

An exemplary synthetic latex (Example 1) is prepared by charging into an agitated 2 gallon reactor 1,620 grams (g) of deionized (DI) water, 49.2 g of a 1 percent aqueous solution of VERSENOL 120 (available from The Dow Chemical Company, Midland Mich., USA), and 7.5 g of polystyrene seed latex, and heating this initial charge to 100° C. A monomer feed including 1,477 g (60 weight percent) methyl acrylate and 985 g (40 weight percent) methyl methacrylate is fed at a rate of 4.92 grams per minute (g/min) for 40 minutes, and then fed to the reactor at a rate of 14.15 g/min for 160 minutes. An aqueous feed including 599 g DI water, 23.1 g Calsoft L40-XS (40 percent active, available from Pilot Chemical Company), 6.9 g sodium persulfate, and 1.9 g sodium bicarbonate is fed to the reactor at 3.16 g/min for 200 minutes starting at the same time as the monomer feed. Upon completion of the feeds, the reactor is maintained at 100° C. for 40 minutes, and the latex is cooled and filtered through a 200 mesh screen.

The latexes of Examples 2 and 3 are made in a similar fashion as that described for Example 1, except that the monomer feed for Example 2 contains 1,723 g (70 weight percent) methyl acrylate and 738 g (30 weight percent) methyl methacrylate, and the monomer feed for Example 3 contains 1,723 g (70 weight percent) methyl acrylate, 492 g (20 weight percent) butyl acrylate, 244 g (9.9 weight percent) methyl methacrylate, and 2.5 g (0.1 weight percent) divinyl benzene.

### Example 4

A latex is prepared by charging into a 2 gallon reactor 2,347 g DI water, 37.9 g of a 1 percent aqueous solution of VERSENOL 120, and 5.8 g of polystyrene seed latex, and heating this initial charge to 100° C. A monomer feed including 1,325 g (70 weight percent) methyl acrylate, 509 g (26.9 weight percent) butyl acrylate, 56.8 g (3 weight percent) methacrylic acid, and 1.89 g (0.1 weight part) divinyl benzene is fed to the reactor at a rate of 3.79 g/min for 40 minutes, and then at a rate of 10.9 g/min for 160 minutes. An aqueous feed including 461 g DI water, 17.8 g Calsoft L40-XS, 5.3 g sodium persulfate, and 1.4 g sodium bicarbonate is fed to the reactor at 2.43 g/min for 200 minutes starting at the same time as the monomer feed. Upon completion of the feeds, the reactor is maintained at 100° C. for 40 minutes, and the latex is then cooled and filtered through a 200 mesh screen.

### Example 5

A latex is prepared in the same manner as describe in Example 4, except that the monomer feed contains 1,325 g (70 weight percent) methyl acrylate, 538 g (28.4 weight percent) butyl acrylate, 28.4 g (1.5 weight percent) methacrylic acid, and 1.9 g (0.1 weight percent) divinyl benzene.

### Example 6

A latex is prepared by charging into a 2 gallon reactor 1,588 g DI water, 28.4 g of a 1 percent aqueous solution of VERSENOL 120, and 8.4 g of polystyrene seed latex and heating this initial charge to 100° C. A monomer feed including 711 g (50 weight percent) methyl methacrylate is fed to the reactor at a rate of 5.92 g/min for 120 minutes. A separate monomer feed including 711 g (50 weight percent) of acrylonitrile is fed to the reactor at a rate of 5.92 g/min for 1.20 minutes. An aqueous feed including 284 g DI water, 15.1 g Calsoft L40-XS, and 2.8 g sodium persulfate is fed to the reactor at 2.52 g/min for 120 minutes starting at the same time as the monomer feeds. Upon completion of the feeds, the reactor is maintained at 100° C. for 30 minutes, and the latex is then cooled and filtered through a 200 mesh screen

Table 1 presents the percent solids, volume mean particle size (Mᵥ), and viscosity measurements for Examples 1 thru 6. Volume mean particle size is measured using a Microtrac UPA 150 Particle Size Analyzer (available from Microtrac, Inc., Montgomery, Pa., USA).

TABLE 1

| | Example | Example | Example | Example | Example | Example |
|---|---|---|---|---|---|---|
| | 1 | 2 | 3 | 4 | 5 | 6 |
| Percent Solids | 51.3 | 51.1 | 51.9 | 39.4 | 39.0 | 29.1 |
| Particle Size, | 0.31 | 0.27 | 0.29 | 0.28 | 0.28 | 0.31 |
| Mᵥ, microns | | | | | | |
| Viscosity, cps | 34 | 29 | 69 | 19 | 21 | 12 |

### Example 7

The latexes of Examples 1 thru 5 are diluted with water to obtain a solids content of 30 percent. The viscosities are measured and are presented in Table 2.

TABLE 2

| | Example | Example | Example | Example | Example |
|---|---|---|---|---|---|
| | 1 | 2 | 3 | 4 | 5 |
| Viscosity, | 15 | 13 | 16 | 14 | 14 |
| cps | | | | | |

As shown in Table 2, the viscosities of the synthetic latexes at 30 percent solids are less than 20 cps. These viscosity values are expected for latexes of these compositions prepared using hydrophobic monomers.

### Examples 8-13

Aqueous compositions are prepared at approximately 5 percent total solids content including Dl water, 20 weight percent NaOH solution, based on total solution weight, and the latexes described in Examples 1-6. A representative composition is prepared by charging 30.0 g of 20 weight percent NaOH solution, based on total solution weight, to a container, adding 866.2 g DI water, and mixing the contents while 83.8 g of the latex prepared as described in Example 1 is added. The similar composition amounts for Examples 1-6 are shown in Table 3. The percent polymer dispersion in the compositions is 4.3 percent due to the solids contribution of the NaOH solution.

TABLE 3

| | Example | Example | Example | Example | Example | Example |
|---|---|---|---|---|---|---|
| | 8 | 9 | 10 | 11 | 12 | 13 |
| 20% NaOH, g | 30.0 | 34.1 | 38.8 | 33.9 | 34.9 | 37.7 |
| DI Water, g | 866.2 | 860.6 | 839.2 | 800.3 | 836.8 | 775.6 |
| Latex, g | 83.8 | 81.8 | 77.1 | 101.4 | 107.8 | 137.6 |
| Latex | Example | Example | Example | Example | Example | Example |
| Sample | 1 | 2 | 3 | 4 | 5 | 6 |
| Total % | 5.0 | 5.0 | 5.0 | 5.0 | 5.0 | 5.0 |
| Solids | | | | | | |
| Polymer % | 4.3 | 4.3 | 4.3 | 4.3 | 4.3 | 4.3 |
| Solids | | | | | | |

### Example 14

The viscosities of the compositions of Examples 8-13 aged at 60° C. or 90° C. are shown in Table 4. The initial viscosities are measured using a Physica MCR 301 rheometer with a 0.05 millimeter (mm) gap at 20 rpm. The aged viscosities are measured using a Brookfield DV-II viscometer at 50 rpm.

TABLE 4
Viscosity (cps)

| | Example 8 | Example 10 | Example 11 | Example 12 | Example 9 | Example 13 |
|---|---|---|---|---|---|---|
| Days | 60° C. | 60° C. | 60° C. | 60° C. | 90° C. | 90° C. |
| 0 | 1.1 | 1.2 | 1.4 | 1.2 | 1.1 | 1.2 |
| 1 | <7 | 26 | 3270 | 3690 | | 2010 |
| 2 | | 946 | 3590 | 3810 | 1344 | |
| 3 | | | | | 1378 | 3210 |
| 4 | | | 4050 | | | |
| 5 | 920 | | | | | |
| 6 | | 1138 | | | | |
| 9 | 1070 | | | | | |
| 10 | | | | | | 2580 |
| 12 | | | | 3930 | 1312 | |
| 16 | | | 4890 | | | |
| 18 | | 1294 | | | | |
| 26 | 948 | | | 4120 | | |
| 30 | | | 4590 | | | |
| 32 | | 1338 | | | | |
| 33 | | | | | 1176 | 1850 |
| 40 | 1098 | | | | | |

As shown in Table 4, the extent and rate of expansion is highly dependent on the polymer composition. Large magnitude increases in viscosity are seen, indicating significant swelling and expansion of the particles of the hydrophobic polymers.

### Examples 15-18

Example 8 is repeated using aqueous compositions of Examples 4 and 5 to prepare dispersions having 1 percent and 3 percent total solids. The composition amounts are shown in Table 5

TABLE 5

| | Example | Example | Example | Example |
|---|---|---|---|---|
| | 15 | 16 | 17 | 18 |
| 20% NaOH, g | 6.8 | 21.2 | 11.9 | 11.6 |
| DI Water, g | 908.6 | 890.1 | 907.8 | 902.9 |
| Latex, g | 20.3 | 63.4 | 17.8 | 18.0 |
| Latex Sample | Example | Example | Example | Example |
| | 4 | 4 | 4 | 5 |
| Total % Solids | 1.0 | 3.0 | 1.0 | 1.0 |
| Polymer % | 0.86 | 2.57 | 0.75 | 0.75 |
| Solids | | | | |

### Example 18

The compositions of Examples 15-18 are aged at 60° C. and the viscosity is measured at various intervals. Table 6 shows the viscosity measurements of the aged samples. The initial viscosities are measured using a Physica MCR 301 rheometer with a 0.05 mm gap at 20 rpm. The aged viscosities are measured using a Brookfield DV-II viscometer at 50 rpm.

TABLE 6
Viscosity (cps)

| | Example | Example | Example | Example |
|---|---|---|---|---|
| Days | 15 | 16 | 17 | 18 |
| 0 | 1.1 | 1.2 | 1.2 | 1.2 |
| 1 | <7 | 760 | 32 | <7 |
| 2 | 14 | 872 | | |
| 11 | | | 72 | 82 |
| 12 | 88 | 1050 | | |
| 25 | | | 80 | 80 |
| 26 | 112 | 1168 | | |

As seen in Table 6, a sizable increase in viscosity is obtained, indicating effective swelling and expansion of the particles.

### Example 19

A synthetic reservoir brine is made with the composition shown in Table 7, below. A 5 percent aqueous dispersion of Example 4 is then made in a manner similar to that described in Example 11, except that the synthetic brine replaces the DI water. The dispersion is aged at 60° C., and the viscosity is measured at various intervals using a Brookfield DV-II viscometer at 50 rpm at 23° C. The initial viscosity is measured using a Physica MCR 301 rheometer with a 0.05 mm gap at 20 rpm. The viscosity values are shown in Table 8.

TABLE 7

| | Parts per |
|---|---|
| Component | million (ppm) |
| NaCl | 1,000 |
| NaHCO₃ | 400 |
| CaCl₂ | 60 |
| Na₂SO₄ | 20 |
| MgCl₂ | 20 |
| KCl | 20 |

TABLE 8
Viscosity (cps)

| | Example |
|---|---|
| Days | 19 |
| 0 | 1.4 |
| 1 | 1016 |
| 2 | 1592 |
| 4 | 1928 |
| 9 | 2624 |
| 14 | 2880 |

As seen in Table 8, the polymer dispersion provides a substantial viscosity increase in the presence of common reservoir ions.

### Example 20

The total solubility parameters (δ_{Total}) of the polymers of Examples 1 thru 6 are calculated using the method described in the description herein, and are shown in Table 9. The polymers are hydrophobic with total solubility parameters of 13.0 (cal/cc)^{1/2} or less.

TABLE 9

| | Example | Example | Example | Example | Example | Example |
|---|---|---|---|---|---|---|
| | 1 | 2 | 3 | 4 | 5 | 6 |
| δ_{Total} | 9.95 | 10.03 | 9.95 | 10.14 | 10.11 | 10.95 |
| ((cal/cc)^{1/2}) | | | | | | |
| δ_{H-Bonding} | 3.32 | 2.77 | 3.52 | 3.70 | 3.63 | 4.58 |
| δ_{Polar} | 5.56 | 5.61 | 5.46 | 5.48 | 5.43 | 6.73 |
| δ_{Non-Polar} | 7.54 | 7.53 | 7.64 | 7.63 | 7.66 | 6.99 |

### Example 21

Dilute the latexes of Examples 2, 4 and 5 to 3 weight percent solids with DI water. Dilute commercially available alkali swellable latexes ACRYSOL TT 615 (ROHM and HAAS), UCAR Polyphobe 106 HE (The Dow Chemical Company), and UCAR Polyphobe TR-115 (The Dow Chemical Company) to 3 weight percent solids with DI water. Measure the viscosity of the diluted samples at 23° C. using the Physica MCR 301 rheometer with a 0.05 millimeter (mm) gap at 20 rpm.

Add an aqueous solution of 5 weight percent NaOH to each latex sample to increase the pH of the sample to 10. Measure the sample pH and viscosity at 23° C. ten minutes after adding the NaOH solution. For the commercially available alkali swellable latexes, a pH of only about 6 was achieved. For Examples 2, 4, and 5 make the viscosity measurements using the Physica MCR 301 rheometer, and the Brookfield DV-11 viscometer for the alkali swellable latexes.

The viscosity and pH results are shown in Table 10. It is seen in that the latexes of Examples 2, 4, and 5 maintain relatively low viscosities at elevated pH (>10), whereas the commercial alkali swellable latexes exhibit very high viscosities even at much lower —pH levels (˜6). Further addition of 5% NaOH to the alkali swellable latexes resulted in the formation of extremely viscous gel-like material with exceptionally high viscosities.

TABLE 10

| | Example | Example | Example | Acrysol | Polyphobe | Polyphobe |
|---|---|---|---|---|---|---|
| | 2 | 4 | 5 | TT 615 | 106 HE | TR-115 |
| Viscosity | 1.0 | 1.0 | 1.0 | 1.1 | 1.0 | 8 |
| before NaOH | | | | | | |
| addition, cps | | | | | | |
| Viscosity | 1.0 | 1.6 | 1.2 | 6200 | 20600 | 18500 |
| after NaOH | | | | | | |
| addition, cps | | | | | | |
| pH after NaOH | 10.6 | 10.8 | 10.3 | 5.9 | 5.8 | 5.8 |
| addition | | | | | | |

This example illustrates differences in the response of aqueous compositions of example latexes of the present disclosure and commercially available alkali swellable latexes. As illustrated, the aqueous compositions containing the commercial alkali swellable latexes undergo a rapid and large viscosity increase as acid groups on the polymer chains become ionized, imbibe water, and swell the particles when the pH of the aqueous composition is increased. In contrast, the aqueous compositions containing the latexes of Examples 2, 4, and 5 of the present disclosure experience only a minor viscosity increase when the pH is increased, since relatively few acid groups are initially present and accessible for ionization. For these latexes, large magnitude increases in viscosity and particle swelling can be delayed until the hydrolysis reaction occurs and forms acid groups along the particle polymer chains. This delay in particle swelling and viscosity increase can be advantageous in oil recovery operations, as it allows for greater injectivity of the particles near the wellbore, and allows the particles to be injected further from the wellbore before plugging the reservoir.

In the foregoing description, various features are grouped together in exemplary embodiments for the purpose of streamlining the disclosure. This method of disclosure is not to be interpreted as reflecting an intention that any claim requires more features than are expressly recited in the claim. Rather, as the following claims reflect, inventive subject matter lies in less than all features of a single disclosed embodiment. Thus, the following claims are hereby incorporated into the description, with each claim standing on its own as a separate embodiment of the invention.

What is claimed:

1. An aqueous composition for enhanced hydrocarbon fluid recovery in a subterranean formation, comprising:
particles of a hydrophobic polymer having constitutional repeating units of which at least 10 percent are hydrolysable to increase a viscosity of the aqueous composition within the subterranean formation.

2. The aqueous composition of claim 1, where the hydrophobic polymer has 4 weight percent or less of its constitutional repeating units derived from a monoethylenically unsaturated carboxylic acid.

3. The aqueous composition of claim I, where the particles of the hydrophobic polymer having constitutional repeating units of which at least 20 percent are hydrolysable and through hydrolysis increase the viscosity of the aqueous composition within the subterranean formation.

4. The aqueous composition of claim 1, where the viscosity of the aqueous composition having 3 or more weight percent of the particles is less than 20 cp at 23° C. and at a pH of 10 or greater before the constitutional repeating units undergo hydrolysis.

5. The aqueous composition of claim 1, where the particles of the hydrophobic polymer include a hydrophobic polymer with a calculated total solubility parameter of 13.0 or less (cal/cc)^{1/2}.

6. The aqueous composition of claim 1, where the particles of the hydrophobic polymer are formed from monomers, of which at least 90 weight percent are hydrophobic monomers, where the hydrophobic monomers have a solubility in water of less than 10 weight percent.

7. The aqueous composition of claim 1, where the particles of the hydrophobic polymer in the aqueous composition do not include a labile cross-linking agent.

8. The aqueous composition of claim 1, where the particles of the hydrophobic polymer maintain an unexpanded state in the aqueous composition without a labile cross-linking agent.

9. The aqueous composition of claim 1, where the particles of the hydrophobic polymer have an unexpanded volume average particle diameter of 0.05 to 10 micrometers.

10. The aqueous composition of claim 1, where the particles of the hydrophobic polymer include a non-labile cross-linking agent.

11. The aqueous composition of claim 1, where monomers used to form the hydrophobic polymer include a hydrolysable monomer selected from the group of methyl acrylate, ethyl acrylate, 2-hydroxyethyl acrylate, n-butyl acrylate, tert-butyl acrylate, sec-butyl acrylate, n-propyl acrylate, acrylonitrile, vinyl acetate, and a combination thereof.

12. The aqueous composition of claim 1, where monomers used to form the hydrophobic polymer include a monomer selected from the group of methyl methacrylate, ethyl methacrylate, n-butyl methacrylate, sec-butyl methacrylate, styrene, and a combination thereof.

13. The aqueous composition of claim 1, where monomers used to form the hydrophobic polymer include more than 5 parts of the hydrolysable monomer based on 100 parts by weight of the hydrophobic polymer total.

14. The aqueous composition of claim 1, where the hydrophobic polymer undergoes hydrolysis at a temperature of at least 30° C. and at a pH greater than 8.0.

15. A method for enhanced hydrocarbon fluid recovery, comprising:
injecting an aqueous composition into a subterranean formation, where the aqueous composition includes particles of a hydrophobic polymer having constitutional repeating units of which at least 10 percent are hydrolysable; and
allowing the at least 10 percent of the constitutional repeating units to hydrolyze within the subterranean formation to increase a viscosity of the aqueous composition.

16. The method of claim 15, including treating the subterranean formation with the aqueous composition having 5 weight percent and below of the particles of the hydrophobic polymer.

17. The method of claim 15, where the method includes maintaining the particles of the hydrophobic polymer in an unexpanded state without a labile cross-linking agent.

18. The method of claim 15, including controlling an extent of expansion of the particles of the hydrophobic polymer with a temperature, a type of added base, an amount of added base, a concentration of added base, a pH, or a combination thereof in the subterranean formation.

19. The method of claim 15, including modifying a water permeability of the subterranean formation with the particles of the hydrophobic polymer.

20. A hydrocarbon fluid recovered using the process of claim 15.
